(19) United States
(12) Patent Application Publication
(10) Pub. No.: US 2012/0330880 A1
(43) Pub. Date: Dec. 27, 2012

(54) SYNTHETIC DATA GENERATION

(75) Inventors: Arvind Arasu, Bothell, WA (US); Kaushik Shriraghav, Bellevue, WA (US); Jian Li, Greenbelt, MD (US)

(73) Assignee: Microsoft Corporation, Redmond, WA (US)

(21) Appl. No.: 13/166,831

(22) Filed: Jun. 23, 2011

(51) Int. Cl. G06F 17/30; G06N 5/02

(52) U.S. Cl. 706/52; 707/803; 707/E17.005

(57) ABSTRACT

The claimed subject matter provides a method for data generation. The method includes identifying a generative probability distribution based on one or more cardinality constraints for populating a database table. The method also includes selecting one or more values for a corresponding one or more attributes in the database table based on the generative probability distribution and the cardinality constraints. Additionally, the method includes generating a tuple for the database table. The tuple comprises the one or more values.

### BACKGROUND

Data generation refers to the population of synthetic databases. Synthetic databases are typically used in a number of applications, including database management system (DBMS) and other software testing, data masking, benchmarking, etc. One use of synthetic data is for testing database operations when it is not practical to use actual data. For example, synthetic data may be used to evaluate the performance of a database without disclosing actual data, which may contain confidential or private information.

Current approaches to the generation of synthetic data are either cumbersome to employ, or have other fundamental limitations. The limitations may relate to data characteristics that can be captured, and efficiently supported in the synthetic database. If data characteristics of the synthetic data are not sufficiently close to actual data that will be used in the database, testing of database operations using the synthetic data will be less accurate than may be desirable.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter provides a method for data generation. The method includes identifying a generative probability distribution based on one or more cardinality constraints for populating a database table. The method also includes selecting one or more values for a corresponding one or more attributes in the database table based on the generative probability distribution and the cardinality constraints. Additionally, the method includes generating a tuple for the database table. The tuple comprises the one or more values.

Additionally, the claimed subject matter provides a system for data generation. The system may include a processing unit and a system memory. The system memory may include code configured to direct the processing unit to construct a Markov network for a data generation problem (DGP). The DGP includes one or more cardinality constraints for populating a database table. The Markov network includes a graph including one or more vertices and one or more edges between the vertices. The Markov network may be converted to a chordal graph. One or more maximal cliques for the chordal graph may be identified. A plurality of marginal distributions of the maximal cliques may be solved for. A generative probability distribution may be constructed using the marginal distributions.

Further, the claimed subject matter provides one or more computer-readable storage media. The computer-readable storage media may include code configured to direct a processing unit to construct a Markov network for a DGP including a plurality of cardinality constraints for populating one or more database tables. One or more maximal cliques for the Markov network may be identified. A plurality of marginal distributions of the maximal cliques may be solved for. A generative probability distribution may be constructed using the marginal distributions. One or more values for a corresponding one or more attributes in the database tables may be selected based on the generative probability distribution and the cardinality constraints. A plurality of tuples may be generated for the plurality of database tables. Each of the tuples includes the one or more values.

### BRIEF DESCRIPTION OF THE DRAWINGS

FIG. 1 is a block diagram of a system in accordance with the claimed subject matter;

FIG. 2 is a process flow diagram of a method for data generation of a single table, in accordance with the claimed subject matter;

FIG. 3 is a block diagram of path graphs for Markov networks, in accordance with the claimed subject matter;

FIG. 4 is a process flow diagram of a method for identifying a generative probability distribution, in accordance with the claimed subject matter;

FIG. 5 is a process flow diagram of a method for identifying a generative probability distribution, in accordance with the claimed subject matter;

FIG. 6 is a block diagram of a snowflake schema, in accordance with the claimed subject matter;

FIG. 7 is a process flow diagram of a method for multiple table data generation, in accordance with the claimed subject matter;

FIG. 8 is a block diagram of an exemplary networking environment wherein aspects of the claimed subject matter can be employed; and

FIG. 9 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, the terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

### Introduction

In one embodiment, cardinality constraints may be used as a natural, expressive, and declarative mechanism for specifying data characteristics of a database. A cardinality constraint specifies that the output of a specific query over the synthetic database have a certain cardinality. Cardinality represents a number of rows, for example, that are generated to populate synthetic databases. Synthetic databases populated with data according to the cardinality constraint may possess the specified data characteristic. While data generation is generally intractable, in one embodiment, efficient algorithms may be used to handle a large, useful, and complex class of cardinality constraints. The following discussion includes an empirical evaluation illustrating algorithms that handle such constraints. Advantageously, synthetic databases populated accordingly scale well with the number of constraints, and outperform current approaches. In one approach to generate synthetic databases, annotated query plans are used. Annotated query plans (AQPs) specify cardinality constraints with parameters. In one embodiment, cardinality constraints with parameters may be transformed to cardinality constraints not involving parameters, for a large class of constraints.

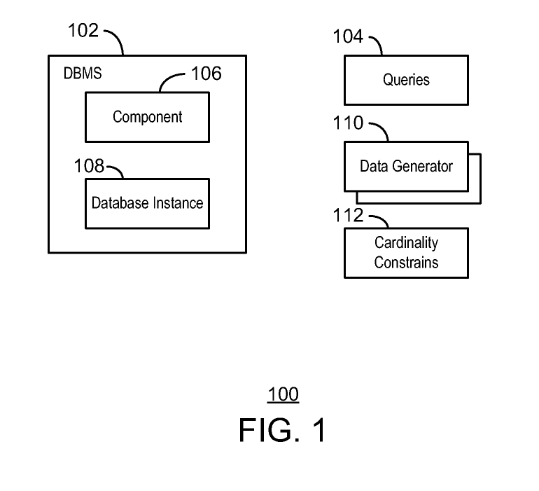

FIG. 1 is a block diagram of a system 100 in accordance with the claimed subject matter. The system 100 includes a DBMS 102, queries 104, a data generator 110, and cardinality constraints 112. The queries 104 are executed against the DBMS 102 for various applications, such as testing the DBMS 102. The DBMS 102 may be tested when new, or updated, DBMS components 106 are implemented. The DBMS component 106 may be a new join operator, a new memory manager, etc. The queries 104 may be run, more specifically, against one or more database instances 108. A database instance 108 may be a synthetic database that has specified characteristics. Normally, databases are populated over extended periods of time. The data in such databases results from the execution of many, and various, automated transactions. In contrast, a synthetic database is one where the data populating the database is automatically generated in a brief period of time, typically by a single piece of software, or a software package. The data generator 110 may generate a single database instance 108 based on the cardinality constraints 112. Further, the dependence on the generated database size is limited to the cost of materializing the database, i.e., storing the data. This is advantageous over current approaches where computational costs for generating the data increase rapidly with the size of the generated database. In one embodiment, the data generator 110 may estimate cardinality constraints 112 according to a maximum entropy principle.

The cardinality constraints 112 may represent the specified characteristics of the database instance 108. The specified characteristics of the database instance 108 may be used to test correctness, performance, etc., of the component 106. For example, the component 106 may be a code module of a hybrid hash join that handles spills to hard disk from memory. To test the component 106, a database instance 108 with the characteristic of a high skew on an outer join attribute may be useful. Another possible application may involve studying the interaction of the memory manager and multiple hash join operators. To implement such an application, a database instance 108 that has specific intermediate result cardinalities for a given query plan may be useful.

The database instance 108 may also be used in data masking, database application testing, benchmarking, and upscaling. In some cases, organizations may use a source database that serves as a source for data values to be included in a synthetic database. However, when organizations outsource database testing, internal databases may not be shared with third parties due to privacy, or other considerations. Data masking refers to the masking of private information, so that such information remains private. Generating the database instance 108 provides a data masking solution because the database instance 108 may be used in place of internal databases. Benchmarking is a process for evaluating performance standards against hardware, software, etc. Benchmarking is useful to clients deciding between multiple competing data management solutions. Standard benchmarking solutions may not include databases with data that reflects application scenarios, and data characteristics of interest to the customer. However, the data generator 110 may create database instances 108 that embody such scenarios and characteristics. In upscaling, the database instance 108 is a database that shares characteristics with an existing database, but is typically much larger. Upscaling is typically used for future capacity planning.

Such applications typically use data generation to produce synthetic databases with a wide variety of data characteristics. Some of these characteristics may result from constraints of the DBMS 102. Such characteristics include, for example, schema properties, functional dependencies, domain constraints, etc. Schema properties may include keys, and referential integrity constraints. Domain constraints may reflect specified data characteristics, such as an age being an integer between 0 and 120. Such constraints may be needed for the proper functioning of the applications being tested. If application testing involves a user interface, where a tester enters values in the fields of a form, the database instance 108 may have a ‘naturalness’ characteristic. For example, values in address, city, state fields may have this characteristic if they look like real addresses.

In benchmarking and DBMS testing, characteristics may include those that influence the performance of queries 104 over the database instance 108. Such characteristics may include, for example, ensuring that values in a specified column be distributed in a particular way, ensuring that values in the column have a certain skew, or ensuring that two or more columns are correlated. Correlations may involve the joining of multiple tables. For example, in a customer-product-order database, establishing correlations between the age of customers and the category of products they purchase may be useful.

In addition to the richness of data characteristics, it is useful in some applications to have database instances 108 where multiple characteristics are simultaneously satisfied. Accordingly, in one embodiment, the data generator 110 may use a declarative approach to data generation, as opposed to a procedural approach. For example, the database instance 108 may include a customer, product, and order database with correlations between several pairs of columns such as customer age and product category; customer age and income; and, product category and supplier location. In the procedural approach, a programmer may design a procedure, with procedural primitives, that provides as output a database with the preferred characteristics. However, by using a declarative language that is natural and expressive, the data generator 110 may automatically generate a database instance 108 with the same characteristics. In one embodiment, the cardinality constraints 112 may specify these characteristics in a declarative language. Similarly, histograms are metadata about a database that describes various statistics. A histogram may describe a distribution of values in the database instance 108 for a column. In one embodiment, the histogram can be represented as a set of cardinality constraints 112, one constraint for each bucket. A bucket is a range of values for a column, tracked in a histogram. For example, a histogram on an “Age” column might be something like [0, 10]=10,000, [10,20]=15000, which represents that there are 10,000 records with Age in the range [5,10], and 15,000 records with Age in the range [10,20]. Each of the cardinality constraints 112 may specify an output size for a specific query. Accordingly, running the specified query against the database instance 108 may produce a result with the specified output size, i.e., cardinality. For example, a cardinality constraint 112 may specify a cardinality of 400 for a query that selects customers with ages between 18 and 35 years. The data generator 110 generates the database instance 108 according the constraint. As such, running the specified query against the database instance 108 may produce a result of 400 tuples, e.g., customers.

In one embodiment, the data generator 110 may use efficient algorithms to generate database instances that satisfy a given set of cardinality constraints 112. The set of cardinality constraints 112 may be large, scaling into the thousands. In comparison, a histogram may be represented as a set of cardinality constraints. A simple histogram may involve hundreds of constraints. The queries for such constraints may be complex, involving joins over multiple tables. By treating a histogram as a set of cardinality constraints 112, database instances 108 may be generated that reflect characteristics of a source database containing the histogram, without necessarily compromising concerns of privacy, or data masking.

Cardinality constraints 112 are further described using the following notation: A relation, R, with attributes A₁, . . . , Aₙ is represented as R(A₁, . . . , Aₙ). The attributes of R are represented as Attr (R)={A₁, . . . , Aₙ}. A database, D, is a collection of relations R₁, . . . , R₁. Given the schema of D, a cardinality constraint 112 may be expressed as |π_{A}σ_{P} (Rᵢ_{₁} [symbol] . . . [symbol] Rᵢ_{ₚ})|=k, where A is a set of attributes, P is a selection predicate, and k is a non-negative integer. A relational expression may be composed using the relations and selection predicate. A database instance satisfies a cardinality constraint 112 if evaluating the relational expression over D produces k tuples in the output. In the following discussion, relations are considered to be bags, meaning that the relations may include tuples with matching attribute values. In other words, one tuple has the same values, in each of its attributes, as another tuple. Further, relational operators are considered to use bag semantics, meaning that the operators may produce tuples with matching attribute values. In contrast to set semantics, bag semantics allow the same element, tuple, etc., to appear multiple times.

The projection operator for queries specified in cardinality constraints 112 is duplicate eliminating. The projection operator: π. projects tuples on a subset of attributes. For example, projection on an attribute, such as, {Gender}, would remove all details except the gender. A duplicate eliminating projection removes duplicates after the projection. As such, a duplicate eliminating projection on Gender is likely to produce just two values: Male and Female. In contrast, a duplicate preserving projection would produce as many values as records in the input table. The input and output cardinalities of a duplicate preserving projection operator are identical, and therefore the cardinality constraints 112 may not include duplicate preserving projections. A set of cardinality constraints 112 may be used to declaratively encode various data characteristics of interest, such as schema properties. A set of attributes Aₖ ⊂ Attr(R) is a key of R using two constraints |π_{A}_{ₖ} (R)|=N and |R|=N. The cardinality constraint 112 specifying that R.A is a foreign key referencing S.B may use the constraints |R [symbol] _{A=B}S|=N and |R|=N. Similarly, more general inclusion dependencies between attribute values of one table and attribute values of another may also be represented in the cardinality constraints 112. Such inclusion dependencies may also be used with reference tables. Reference tables may be used to ensure database characteristics, such as naturalness. For example, to ensure that address fields appear natural, a reference table of U.S. addresses may be used. Accordingly, the naturalness characteristic may be specified with a cardinality constraint 112 stating that the cardinality is zero for a query on a generated address against the reference table. Schema properties may be specified using cardinality constraints 112.

The value distribution of a column may be captured in a histogram. A single dimension histogram may be specified by including one cardinality constraint 112 for each histogram bucket. For example, the cardinality constraint 112 corresponding to the bucket with boundaries [l, h], having k tuples may be represented as |σ_{l≦A≦h}(R)|=k. In this way, correlations may be specified between attributes using multi-dimension histograms, encoded using one constraint for each histogram bucket. Correlations spanning multiple tables may also be specified using joins and multi-dimension histograms. For example, a correlation between customer.age and product.category in a database with Customer, Orders, and Product tables, may be specified using multi-dimension histograms over the view (Customer [symbol] Orders [symbol] Product). Cardinality constraints 112 may also be specified for more complex attribute correlations, join distributions between relations, and a skew of values in a column.

The selection predicate, P, may include conjunctions of range predicates of the form, A ∈ [l, h]. In an equality constraint, l=h. The selection predicate, P, may also include disjunctions and non-equalities, such as ≧, ≦, >, and <. Moreover, the joins may be foreign-key equi-joins. The domain of attribute Aᵢ is represented herein as Dom(Aᵢ). The domains of all attributes may be positive integers without the loss of much generality because values from other domains, such as categorical values (e.g., male/female), may be mapped to positive integers.

This notation is now used to describe a data generation problem (DGP) solved by the data generator 110. Given a collection of cardinality constraints, C₁, . . . , Cₘ, generate a database instance 108 that satisfies all the constraints. A decision version of this problem stated mathematically has an output of Yes if there exists a database instance 108 that satisfies all the constraints. Otherwise, the output of the problem is No. The decision version of this problem is extremely hard, NEXP-complete. While the hardness result of the general data generation problem may be challenging, it is acceptable in practice that the cardinality constraints are only satisfied in expectation or approximately satisfied. As such, the data generator 110 may use efficient algorithms for a large and useful class of constraints.

Generating a single table with a single attribute is a data generation problem that may be solved via a linear program (LP). Let R(A) denote the table being generated. Without loss of generality, each constraint Cⱼ (1≦j≦m) may be in the canonical form |σₗ_{ⱼ}_{≦A<h}_{ⱼ}(R)|=kⱼ. A simple integer linear program (ILP) may solve this DGP. For each i ∈ |D|, there exists an xᵢ that represents the number of copies of i in R. Equation 1 is an algorithm that captures the m constraints.

Σᵢ₌ₗ_{ⱼ}^{h}^{ⱼ}⁻¹xᵢ=kⱼ for j=1, . . . , m EQUATION 1

Further, each x, is a nonnegative integer. Any solution to the above ILP corresponds to a solution of the DGP instance. In general, solving an ILP is NP-hard. However, the above ILP has a structure that shows that a matrix corresponding to the system of equations has a property called unimodularity. This property implies that a solution of the corresponding linear programming (LP) relaxation is integral in the presence of a linear optimization criterion. As such, a dummy criterion may be added in order to get integral solutions. The LP relaxation is obtained by dropping the limitation of the integer domain for xᵢ. In one embodiment using relaxation, xᵢ may be real values. An LP can be solved in polynomial time, but this does not imply a polynomial time solution to DGP since the number of variables in the LP is proportional to domain size D, which may be much larger than the sizes of the input, and the database instance 108 being output.

However, intervalization may be used to reduce the size of the LP. Let v₁=1, v₂= . . . , vₗ=D+1 denote, in increasing order, the distinct constants occurring in predicates of constraints Cⱼ, including constants 1 and D+1. There are (l-1) basic intervals [vᵢ,vᵢ₊ᵢ) (1≦i<l. For each basic interval, [vᵢ, vᵢ₊₁), there exists an x[vᵢ, vᵢ₊₁) representing the number of tuples in R(A) that belong to the interval. A constraint Cⱼ: |σₗ_{ⱼ}_{≦A<r}ⱼ(R)|=kⱼ. By construction, there exist vₚ=lⱼ and v_{q}=rⱼ. Further, Equation 2 captures Cⱼ:

Σᵢ₌ₚ^{q-1}x₍ᵥ_{ᵢ}_{,v}_{ᵢ₊₁}₎₌ₖ_{ⱼ} EQUATION 2

A solution to the above LP can be used to construct a solution for the DGP instance of a single table, single attribute. The number of variables is, at most, twice the number of constraints, implying a polynomial time solution to the DGP. Given an LP solution, the time for generating the actual table is linear to the size of the output, which may be independent of the input size. However, since any algorithm takes linear time, this linear time is not included in the time used for comparing different algorithms for data generation.

An example instance of a DGP has three constraints, |σ_{20≦A<60}(R)|=30, |σ_{40≦A<100}(R)|=40, and |R|=50, and a domain size, D=100. Assuming 4 basic intervals: [1, 20), [20, 40), [40, 60), [60, 101), a corresponding linear program consists of Equations 3-5:

x_{[1,20)}+x_{[20,40)}+x_{[40,60)}+x_{[60,101)}=50 EQUATION 3

x_{[20, 40)}+x_{[40, 60)}=30 EQUATION 4

x_{[40, 60)}+x_{[60, 101)}=40 EQUATION 5

One solution to the LP is x_{[1, 20)}=2, x_{[20, 40)}=8, x_{[40, 60)}=22, and x_{[60, 101)}=18. To generate R(A),two values may be selected randomly from [1, 20), 8 values selected randomly from [20, 40), etc. This intervalization may be used in various embodiments described herein.

The LP approach may be generalized to handle a DGP for a single table with multiple attributes. However, this approach may produce a large, computationally expensive LP. Let R(A₁, . . . , Aₙ) represent the table being generated. Each constraint, Cⱼ, may be represented in the form, |σ_{P}_{ⱼ}(R)|=kⱼ. For conciseness, a constraint Cⱼ may be denoted as a pair <Pⱼ, kⱼ>.

To generate a table with multiple attributes, Equation 1 may be generalized as follows. For every tuple, t ∈ Dom(A₁)×, . . . , Dom(Aₙ), the number of copies of t in R may be represented as xᵢ. For each constraint Cⱼ=<Pⱼ, kⱼ>, a linear equation, shown in Equation 6, may be generated.

$${\sum }_{t : p ( t ) = true} {x}_{t} = {k}_{j} \qquad EQUATION 6$$

With LP relaxation, a solution to Equation 6 might not be consistently integral. Otherwise, the problem could be NP. However, slightly violating some cardinality constraints 112 is acceptable for many applications of data generation. A probabilistically approximate solution may be derived by starting with an LP relaxation solution and performing randomized rounding. For example, xₜ may be rounded to [xₜ] with probability xₜ−[xₜ] and to [xₜ] with probability [xₜ]−xₜ. It can be proven that a relation R generated in this manner satisfies all constraints in the expectation shown in Equation 7:

[symbol]

[|σ_{P}_{ⱼ}(R)|]=kⱼ EQUATION 7

for all constraints Cⱼ. Equation 7 is also referred to herein as LPA_{LG}. However, even with intervalization, the number of variables created by LPA_{LG} can be exponential in the number of attributes. In one embodiment, the data generator 110 may use an algorithm based on graphical models. In this way, if the input constraints are low-dimensional and sparse, data generator 110 may outperform LPA_{LG}.

Another DGP example is discussed below to illustrate a more efficient strategy for data generation than LPA_{LG}. Consider a DGP instance with domain size |D|=2, and 2n+1 constraints |R|=1000, |σ_{A}_{ᵢ}₌₁(R)|=500, and |σ_{A}_{ᵢ}₌₂(R)|=500, where (1≦i≦n). LPA_{LG} solves an LP involving 2ⁿ variables. However, in one embodiment, the attributes are decoupled from one another by generating the values for each attribute independently. For example, one thousand random tuples may be generated, where each tuple is generated by selecting each of its attribute values {1, 2}, uniformly at random. In this way, all constraints in the expectation may be satisfied.

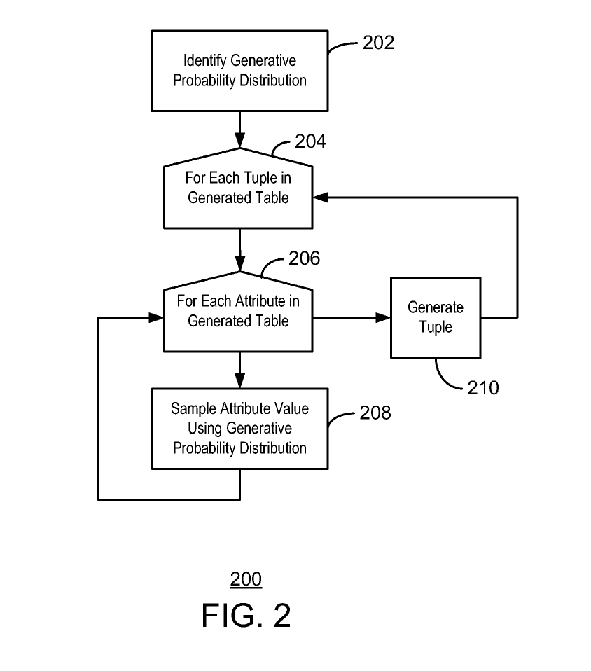

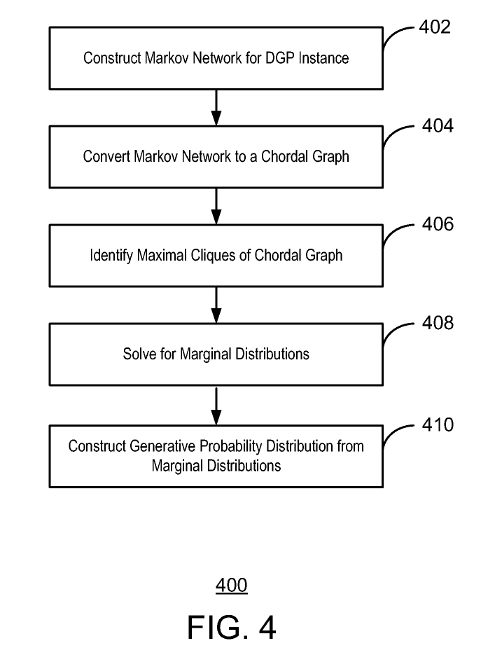

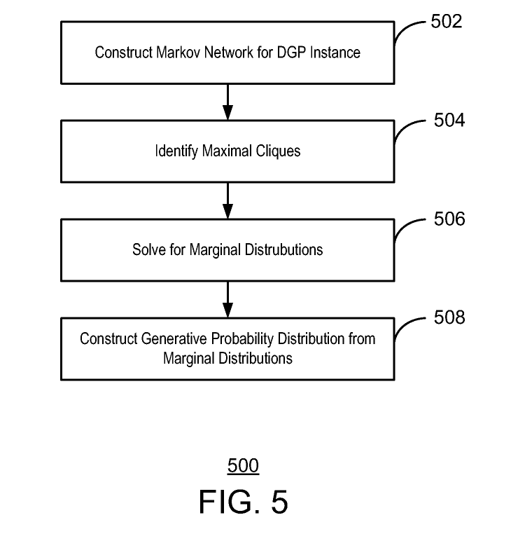

FIG. 2 is a process flow diagram of a method 200 for data generation of a single table, in accordance with the claimed subject matter. The process flow diagram is not intended to indicate a particular order of execution. The method 200 may be performed by the data generator 110, and begins at block 202, where a generative probability distribution, p(X), may be identified. The distribution p(X) satisfies the property that for each constraint Cⱼ=<Pⱼ, kⱼ>, the probability that predicate Pⱼ is true for a tuple sampled from p(X) is kⱼ/N. Distributions with this property are referred to herein as generative. Identifying the generative probability distribution, p(X), is described in greater detail with respect to FIGS. 4 and 5. Blocks 204-210 are repeated for each tuple to be generated. Blocks 206-208 may be repeated for each attribute in the generated tuples. At block 208, the data generator 110 may sample a value for the attribute, using the generated probability distribution, p(X). With each attribute Aᵢ, a random variable may be assigned that assumes values in Dom(Aᵢ). At block 210, the tuple may be generated with the independently sampled values for each attribute.

If a single table DGP, without projections, has a solution, there exists a generative probability distribution function for the DGP. Further, there exists a generative probability distribution function that factorizes into a product of simpler functions. For each constraint Cⱼ=<Pⱼ, kⱼ>, Attrs(Cⱼ) may represent the set of attributes appearing in predicate Pⱼ. Further, X(Cⱼ) may represent the set of random variables corresponding to these attributes. For example, if Cⱼ is |σ_{A}_{₁}_{=5ΛA}_{₃}₌₄(R)|=10, then Attrs(Cⱼ)={A₁, A₃} and X(Cⱼ)={X1, X3}. For any X′ ⊂ X, f(X′) represents a function f over random variables in X′. Function f(X′) maps an assignment of values to random variables in X′ to its range. The range is usually nonnegative real numbers, [symbol] ^{≧0}. If an attribute Aᵢ does not appear in at least one constraint, a constraint may be added, |σ_{1≦A}_{ᵢ}_{≦D}(R)|=N.

If a single table DGP, without projections, has a solution, there exists a generative probability distribution, p(X), that factorizes as shown in Equation 8.

p(X)=Π_{X}_{ᵢ}_{:∃C}_{ⱼ}_{s,t,X}_{ᵢ}_{=X(C}_{ⱼ}₎fᵢ(Xᵢ) EQUATION 8

Consider a DGP instance where Attrs(C₁)=A₁, A₂}, and for all other constraints, Cⱼ (j≠1), |Attrs(Cⱼ)|=1. There exists a generative probability distribution p(X₁, . . . , Xₙ) for this DGP instance that can be expressed as f₁(X₁, X₂)f₃(X₃), . . . , fₙ(Xₙ), where fᵢ are some functions. It is noted that a DGP instance can have several generative probability distributions, and all such distributions do not necessarily factorize as shown in Equation 8. However, there exists at least one generative probability distribution that does.

The factorization of a generative probability distribution implies various independence properties of the distribution. As such it is convenient to use an undirected graph to infer independence properties implied by a factorization. For example, the Markov network of a DGP instance is an undirected graph G=(X, E) with vertices corresponding to random variables X₁, . . . , Xₙ. Further, a graph, G, contains an edge (Xᵢ, Xⱼ) whenever {Xᵢ, Xⱼ} ⊂ X(Cⱼ) for some constraint Cⱼ. The independence properties of distributions p(X) that factorize according to Equation 8, may be characterized as follows. Let X_{A}, X_{B}, X_{C} ⊂ X be nonoverlapping sets such that in a Markov network, G, every path from a vertex in X_{A} to a vertex in X_{B} goes through a vertex in X_{C}. As such, for any probability distribution that factorizes according to Equation 8, (X_{A} ⊥ X_{B}|X_{C}). If X_{A} and X_{B} belong to different connected components, then X_{A} ⊥ X_{B}, unconditionally, for any distribution p(X) that factorizes according to Equation 8. For example, a Markov network for a single table DGP instance may have n vertices, but a single edge (X₁, X₂). There exists a distribution p(X) for which (Xᵢ ⊥ Xⱼ) for all pairs, {Xᵢ, Xⱼ} ≠ {X₁, X₂}. These independences imply that p(X)=p(X₁, X₂)p(X₃) . . . p(Xₙ). As such, the problem of identifying p(X) may be divided into smaller problems of identifying the marginals p(X₁, X₂), p(X₃), . . . , p(Xₙ).

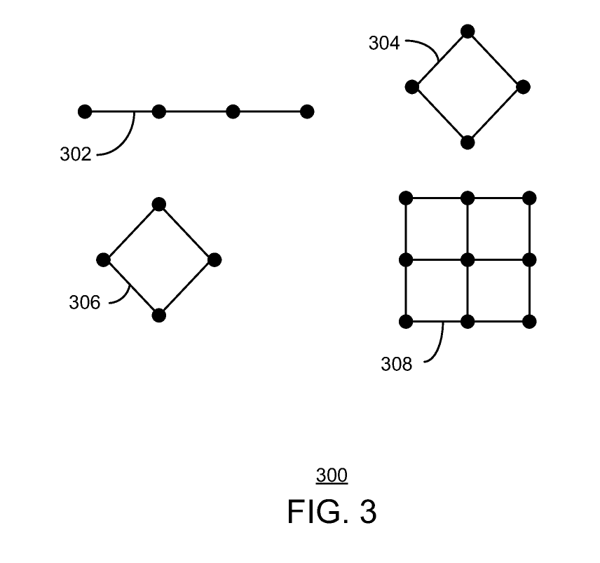

FIG. 3 is a block diagram of path graphs 302, 304, 306, 308 for Markov networks, in accordance with the claimed subject matter. For a DGP instance whose Markov network is the path graph 302, there exists a generative probability distribution, p(X), for which (X₁ ⊥ X₃|X₂). This is true because the only path from X₁ to X₃ passes through X₂. For the path graph 304, (X₁ ⊥ X₃|X₂, X₄), but (X₁ not orthogonal to X₃|X₂). The method 200 operates based on the assumption that the factors fᵢ in Equation 8, allow a natural probabilistic interpretation if the Markov network is a chordal graph. In the language of graphical models, the distribution p(X) is a decomposable distribution if the Markov network is chordal. A graph is chordal if each cycle of length 4 or more has a chord. A chord is an edge joining two non-adjacent nodes of a cycle. The graph path 304 is not chordal, but adding the edge (X₂, X₄) results in the chordal graph shown in path graph 306.

FIG. 4 is a process flow diagram of a method 400 for identifying a generative probability distribution, in accordance with the claimed subject matter. The process flow diagram is not intended to indicate a particular order of execution. The method 400 may be performed by the data generator 110, and begins at block 402, where the Markov network, G, of a DGP instance is constructed. In general, the Markov network of a DGP instance may not be chordal. At block 404, the Markov network G=(X, E) may be converted to a chordal graph, Gc=(X, E_{c}), E ⊂ E_{c}. In one embodiment, the data generator may convert G to G_{c} by adding additional edges. At block 406, the maximal cliques X_{c1}, . . . , X_{c1} of G_{c} may be identified.

At block 408, the data generator 110 may solve for the marginal distributions p(X_{c1}), . . . , p(X_{c1}). To identify the marginal distributions p(X_{c1}), . . . , p(X_{c1}), a system of linear equations may be constructed and solved. The variables in these equations are probability values p(x), x ∈ Dom(X_{ci}) of the distributions p(X_{ci}). In the following discusion, px_{ci} is used to represent the marginal over variables X_{ci}. Using Equations 9-10 below ensures that px_{ci} are valid probability distributions. Using Equation 10 ensures that the marginal distributions satisfy all constraints within their scope.

Σ_{x ∈Dom(X}_{_{ci}}₎px_{ci}(x)=1 1≦i≦l EQUATION 9

Σ_{y ∈Dom(X}_{ci:P}_{ⱼ}₍ₓ₎₌ₜᵣᵤₑpx_{ci}(x)=kⱼ/N X(Cⱼ) ⊂ X_{ci} EQUATION 10

Consider any two cliques X_{ci} and X_{cj} such that X_{ci} ∩ X_{cj} ≠ φ. For any x ∈ Dom(X_{ci} ∩ X_{cj}), let Extₓ_{_{ci}}(x) represent the set of assignments to X_{ci} that is consistent with the assignment x. The linear program may apply Equation 11 for each x ∈ Dom(X_{ci} ∩ X_{cj}).

Σ_{y∈Ext}ₓ_{_{ci}}₍ₓ₎px_{ci}(y)=Σ_{y∈Ext}ₓ_{_{cj}}₍ₓ₎px_{cj}(z) EQUATION 11

The marginal distribution p(X_{ci} ∩ X_{cj})can be computed by starting with p(X_{ci}) and summing out the variables in X_{ci}−X_{cj}. Alternatively, the data generator 110 may start with p(X_{cj}), and sum out variables in X_{cj}−X_{ci}. Either approach provides the same distribution.

At block 410, the data generator 110 may construct the generative probability distribution from the marginal distributions. Chordal graphs have a property that enables such a the construction of the generative probability distribution p(X). The following example illustrates this property. Referring back to FIG. 3, consider a DGP instance whose Markov network is the path graph 302, and let p(X₁, X₂, X₃, X₄) be a distribution that factorizes according to Equation 8. The path graph 302 has no cycles and is therefore chordal with maximal cliques {X₁, X₂}, {X₂, X₃}, and {X₃, X₄}. The generative probability distribution, p(X₁, X₂, X₃, X₄) can be computed using the marginals over these cliques, as shown in Equation 12.

$$\begin{matrix}P ( {X}_{1} , {X}_{2} , {X}_{3} , {X}_{4} = p ( {X}_{1 ,} , {X}_{2} ) p ( {X}_{3} \vert {X}_{1} , {X}_{2} ) , {X}_{3} ) ) \\ p ( {X}_{4} \vert {X}_{1} , {X}_{2} , {X}_{3} ) \\ = p ( {X}_{1 ,} , {X}_{2} ) p ( {X}_{3} \vert {X}_{2} ) p ( {X}_{4} \vert {X}_{3} ) \\ = p ( {X}_{1} , {X}_{2} ) \frac{p ( {X}_{2} , {X}_{3} )}{p ( {X}_{2} )} \frac{p ( {X}_{3} , {X}_{4} )}{p ( {X}_{3} )}\end{matrix} \qquad EQUATION 12$$

The second step of Equation 12, follows from the first using the independence properties of p(X₂) and p(X₃). More specifically, p(X₂) and p(X₃) can be obtained from p(X₂, X₃) by summing out X₃ and X₂, respectively. Sampling from such a distribution may be easy.

Referring back to FIG. 4, the following discussion provides an example implementation of the method 400. Consider a DGP instance R(A₁, A₂, A₃, A₄) with three constraints: |σ_{A}_{=0ΛA}_{₂}₌₀(R)|=5, |σ_{A}_{₂}_{=0ΛA}_{₃}₌₀(R)|=5, and |σ_{A}_{₃}_{=0ΛA}_{₄}₌₀(R)|=5. The size of the table being populated, N, is equal to 10. Additionally, the attributes are all of a binary domain {0, 1}. Referring back to FIG. 3, the Markov network for this DGP instance is the path graph 302. The maximal cliques are the three edges. The system of equations 13-22 may be solved to identify the marginals over the edges. The notation p₁₂(00) is a shorthand for p(X₁=0, X₂=0).

p₁₂(00)+p₁₂(01)+p₁₂(10)+p₁₂(11)=1 EQUATION 13

p₂₃(00)+p₂₃(01)+p₂₃(10)+p₂₃(11)=1 EQUATION 14

P₃₄(00)+P₃₄(01)+P₃₄(10)+p₃₄(11)=1 EQUATION 15

p12(00)=½ EQUATION 16

p23(00)=½ EQUATION 17

p₃₄(00)=½ EQUATION 18

p₁₂(00)+P₁₂(10)=P₂₃(00)+p₂₃(01) EQUATION 19

p₁₂(01)+P₁₂(11)=p₂₃(10)+p₂₃(11) EQUATION 20

p₂₃(00)+P₂₃(10)=p₃₄(00)+p₃₄(01) EQUATION 21

p₂₃(00)+P₂₃(10)=p₃₄(00)+p₃₄(01) EQUATION 22

Equations 13-15 ensure that the marginals are probability distributions. Equations 16-18 ensure that the marginals are consistent with the constraints. Equations 19-22 ensure the marginals produce the same submarginals, p(X₂) and p(X₃). For this DGP instance, the method 200 solves an LP with 12 variables, whereas LPA_{LG} uses 16 variables. While this difference is small, for a similar DGP instance with 10 attributes and domain size D=10, the method 200 uses 9·10²=900 variables, whereas LPA_{LG} uses 10¹⁰ variables.

In another embodiment, the generative probability distribution may be identified by solving for a set of low-dimensional, marginal distributions, using the input constraints. These distributions may be combined to produce the generative probabilistic distribution. FIG. 5 is a process flow diagram of a method 500 for identifying a generative probability distribution, in accordance with the claimed subject matter. The process flow diagram is not intended to indicate a particular order of execution. The method begins at block 502, where a Markov network may be constructed for the DGP instance.

For clarity, the following definitions are used to describe the method 500. Let G=(X, E) denote the Markov network corresponding to the DGP instance. A Markov blanket of a set of variables X_{A} ⊂ X, denoted M(X_{A}), is defined as: M(X_{A})={Xᵢ|(Xᵢ, Xⱼ) ∈ E [symbol] (Xᵢ ∉ X_{A}) [symbol] (Xⱼ ∈ X_{A})}. The Markov blanket of X_{A} is a set of neighbors of vertices in X_{A} not contained in X_{A}. For example, referring back to FIG. 3, the path graph 302 has a Markov blanket, M({X₂})={X₁, X₃}. The following discussion also uses a shorthand, M̅(X_{A}), for M(X_{A}) ∪ X_{A}.

At block 504, maximal cliques X_{c1}, . . . , X_{c1} in the Markov network are identified. At block 506, the marginal distributions p( M̅(X_{c1})), . . . , p( M̅(X_{c1})) may be solved for. This may be accomplished by setting up a system of linear equations similar to Equations 9-10. At block 508, the generative probability distribution p(X) may be constructed by combining the marginal distributions.

The following discussion provides an example implementation of the method 500. Referring back to FIG. 3, consider the n x n grid in path graph 308. For the path graph 308, the maximal cliques are its edges. As such, the marginals solved by the data generator 110 correspond to M̅ ({X₁, X₂})={X₁, X_{2,} X₃, X₄, X₅}, M̅({X₂, X₃})={X₂, X_{3,} X₄, X₅, X₆}, etc. Since each Markov blanket is of a constant size and there are 2(n−1)n edges, there may be, at most, 2n(n−1)×|D|^{O(1)} variables, where D is the domain. The treewidth of an n×n grid is n, which implies the maximum clique of any chordal supergraph of G is at least of size n+1. Therefore, at least |D|ⁿ variables may be used for the chordal graph approach, which is less efficient than the Markov blanket-based approach shown in FIG. 5. In contrast, for the Markov networks in FIG. 2(a)-(c), the chordal graph method is more efficient than the Markov blanket-based approach.

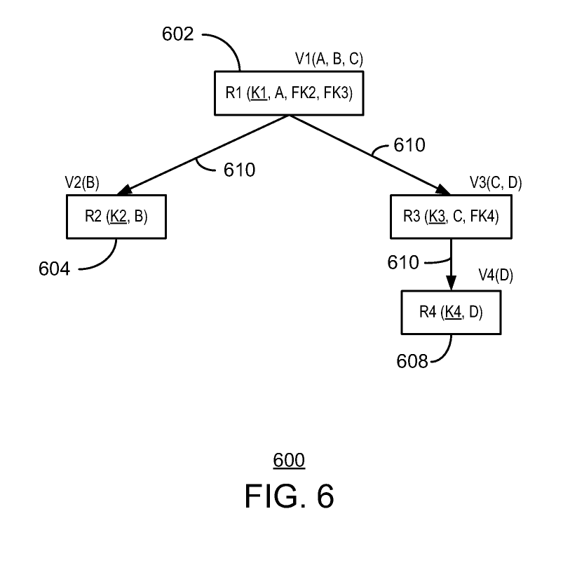

The database instance 108 may also include multiple tables, i.e., relations, generated by the data generator 110. In the following discussion regarding data generation for multiple tables, the DGP instance involves relations R₁, . . . , Rₙ, and constraints C₁, . . . , Cₘ. Each constraint Cⱼ is of the form |σ_{P}_{ⱼ}(Rᵢ₁ [symbol] . . . [symbol] Rᵢ_{ₛ})|. Further, the relations, R₁, . . . , Rₛ may form a snowflake schema, with all joins being foreign key joins. A snowflake schema has a central fact table and several dimension tables which form a hierarchy. FIG. 6 is a block diagram of a snowflake schema 600, in accordance with the claimed subject matter. The snowflake schema 600 is represented as a rooted tree with nodes 602, 604, 606, 608 corresponding to the relations R1-R4 to be populated. The snowflake schema 600 also includes directed edges 610 corresponding to foreign key relationships between the tables. The root of the tree, node 602, represents a fact table. The remaining nodes 604, 606, 608 represent dimension tables. Each table in the snowflake schema 600 has a single key attribute, zero or more foreign keys, and any number of non-key value attributes.

The keys of the tables are underlined and the foreign keys are named by prefixing “F” to the key that they reference. For example, FK2 is the foreign key referencing relation R2, key K2. The value attributes of all the relations include attributes A, B, C, and D. Two example constraints are | [symbol] (R₃ [symbol] R₄)|=20, and |σ_{D=2}(R₁ [symbol] R₃ [symbol] R₄)|=30. Relation, R1, is the parent of relation, R2. For each relation, Rᵢ, a view Vi may be defined by joining all the view's descendant tables, and projecting out non-value attributes. This projection is duplicate preserving unlike the projections in the constraints. For example, associated with node 606, is a view, V3= π̅_{C,D}(R₃ [symbol] R₄), where π̅ indicates a duplicate preserving projection. Each constraint, Cⱼ, may be re-written as a simple selection constraint over only one of the views, Vᵢ. For example, the constraint, | [symbol] (R₃ [symbol] R₄)|=20, can be rewritten as | [symbol] (V₃)|=20.

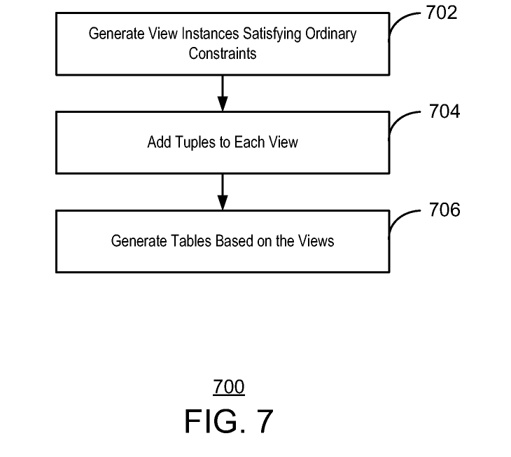

FIG. 7 is a process flow diagram of a method 700 for multiple table data generation, in accordance with the claimed subject matter. The process flow diagram is not intended to indicate a particular order of execution. The method 700 may be performed by the data generator 110, and begins at block 702, where an instance is generated of each view, Vᵢ. The generated instance may satisfy all cardinality constraints associated with the view. Since the constraints are all single table selection constraints, Equations 9-11 may be used to generate these instances. However, these independently generated view instances may not correspond to valid relation instances. For example, relation instances R₁, . . . , Rₙ satisfy all key-foreign key constraints. Let Rₚᵢ represent the parent of a relation Rᵢ. The views Vᵢ and Vₚᵢ satisfy the property π_{Attr(V}_{ᵢ}₎(Vₚᵢ) ⊂ Vᵢ. It is noted that π is duplicate eliminating. Further, the distinct values of B in V1(A, B, C) occurs in some tuple, V2. However, the view instances generated at block 702 may not satisfy this property. Accordingly, at block 704, additional tuples may be added to each Vᵢ to ensure that this containment property is satisfied in the resulting view instances. These updates might cause some cardinality constraints to be violated. However, the degree of these violations may be bounded. At block 706, the tables may be generated based on the views. The relation instances R₁, . . . , Rₙ, consistent with V1, . . . , Vn, may be constructed. In one embodiment, any error introduced at block 704 may be reduced by selecting values from an interval in a consistent manner across the views.

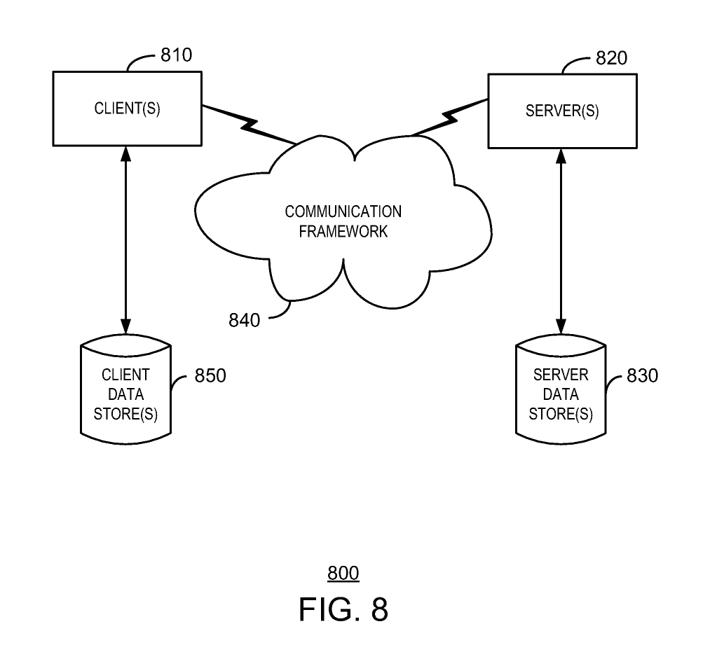

FIG. 8 is a block diagram of an exemplary networking environment 800 wherein aspects of the claimed subject matter can be employed. Moreover, the exemplary networking environment 800 may be used to implement a system and method that generates data for populating synthetic database instances, as described herein.

The networking environment 800 includes one or more client(s) 802. The client(s) 802 can be hardware and/or software (e.g., threads, processes, computing devices). As an example, the client(s) 802 may be computers providing access to servers over a communication framework 808, such as the Internet.

The environment 800 also includes one or more server(s) 804. The server(s) 804 can be hardware and/or software (e.g., threads, processes, computing devices). The server(s) 804 may include network storage systems. The server(s) may be accessed by the client(s) 802.

One possible communication between a client 802 and a server 804 can be in the form of a data packet adapted to be transmitted between two or more computer processes. The environment 800 includes a communication framework 808 that can be employed to facilitate communications between the client(s) 802 and the server(s) 804.

The client(s) 802 are operably connected to one or more client data store(s) 810 that can be employed to store information local to the client(s) 802. The client data store(s) 810 may be located in the client(s) 802, or remotely, such as in a cloud server. Similarly, the server(s) 804 are operably connected to one or more server data store(s) 806 that can be employed to store information local to the servers 804.

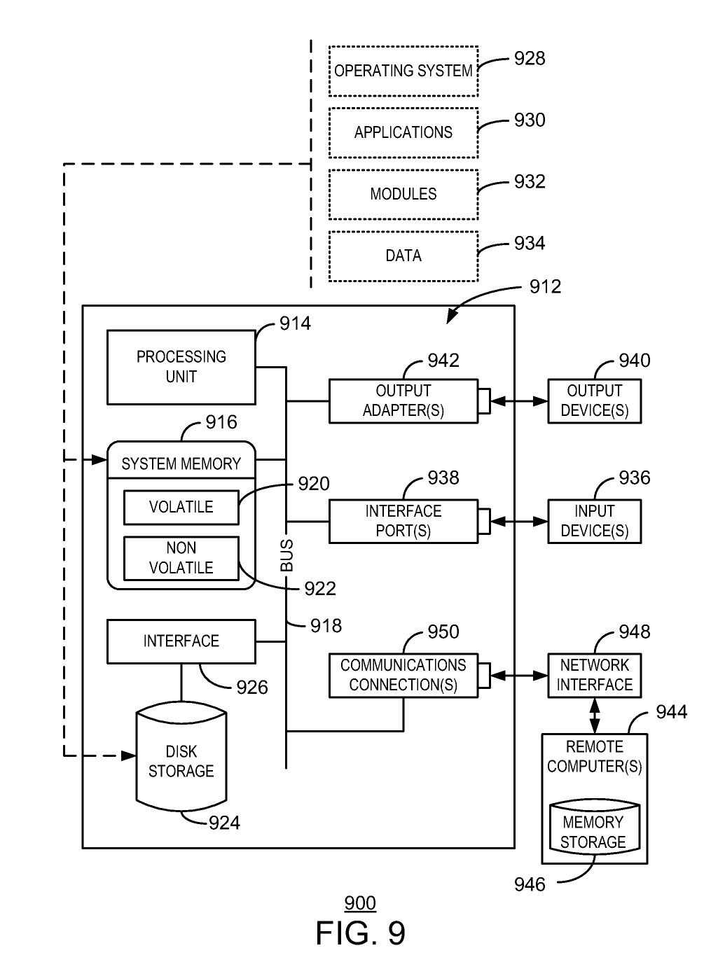

FIG. 9 is a block diagram of an exemplary operating environment 900 for implementing various aspects of the claimed subject matter. The exemplary operating environment 900 includes a computer 912. The computer 912 includes a processing unit 914, a system memory 916, and a system bus 918. In the context of the claimed subject matter, the computer 912 may be configured to generate data for populating synthetic databases.

The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures known to those of ordinary skill in the art. The system memory 916 comprises non-transitory computer-readable storage media that includes volatile memory 920 and nonvolatile memory 922.

The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory.

Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 912 also includes other non-transitory computer-readable media, such as removable/non-removable, volatile/non-volatile computer storage media. FIG. 9 shows, for example a disk storage 924. Disk storage 924 includes, but is not limited to, devices like a magnetic disk drive, floppy disk drive, tape drive, Jaz drive, Zip drive, LS-100 drive, flash memory card, or memory stick.

In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912.

System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 936 connect to the processing unit 914 through the system bus 918 via interface port(s) 938. Interface port(s) 938 include, for example, a serial port, a parallel port, a game port, and a universal serial bus (USB).

Output device(s) 940 use some of the same type of ports as input device(s) 936. Thus, for example, a USB port may be used to provide input to the computer 912, and to output information from computer 912 to an output device 940.

Output adapter 942 is provided to illustrate that there are some output devices 940 like monitors, speakers, and printers, among other output devices 940, which are accessible via adapters. The output adapters 942 include, by way of illustration and not limitation, video and sound cards that provide a means of connection between the output device 940 and the system bus 918. It can be noted that other devices and/or systems of devices provide both input and output capabilities such as remote computer(s) 944.

The computer 912 can be a server hosting various software applications in a networked environment using logical connections to one or more remote computers, such as remote computer(s) 944. The remote computer(s) 944 may be client systems configured with web browsers, PC applications, mobile phone applications, and the like.

The remote computer(s) 944 can be a personal computer, a server, a router, a network PC, a workstation, a microprocessor based appliance, a mobile phone, a peer device or other common network node and the like, and typically includes many or all of the elements described relative to the computer 912.

For purposes of brevity, only a memory storage device 946 is illustrated with remote computer(s) 944. Remote computer(s) 944 is logically connected to the computer 912 through a network interface 948 and then physically connected via a communication connection 950.

Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to the computer 912. The hardware/software for connection to the network interface 948 may include, for exemplary purposes only, internal and external technologies such as, mobile phone switches, modems including regular telephone grade modems, cable modems and DSL modems, ISDN adapters, and Ethernet cards.

An exemplary processing unit 914 for the server may be a computing cluster comprising Intel® Xeon CPUs. The disk storage 924 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for data generation, comprising:
identifying a generative probability distribution based on one or more cardinality constraints for populating a database table;
selecting one or more values for a corresponding one or more attributes in the database table based on the generative probability distribution and the cardinality constraints; and
generating a tuple for the database table, wherein the tuple comprises the one or more values.

2. The method recited in claim 1, wherein each of the cardinality constraint specifies:
the one or more attributes;
a query predicate; and
a cardinality of a result of running a database query comprising the query predicate against the database table.

3. The method recited in claim 2, wherein the generative probability distribution satisfies a property that for each constraint of the cardinality constraints, the probability that the query predicate is true for a tuple sampled from the generative probability distribution is k/N, where k comprises the cardinality, and N comprises a number of tuples in the database table.

4. The method recited in claim 2, wherein one of the cardinality constraints represents a preferred characteristic of a database comprising the database table.

5. The method recited in claim 4, wherein the preferred characteristic is naturalness, and wherein the cardinality is zero, and wherein the query predicate specifies a comparison between a source table comprising natural attribute values and the database table comprising the values.

6. The method recited in claim 1, wherein identifying the generative probability distribution comprises:
constructing a Markov network for a data generation problem (DGP) comprising the cardinality constraints and the database table, wherein the Markov network comprises a graph comprising one or more vertices and one or more edges between the vertices;
converting the Markov network to a chordal graph;
identifying one or more maximal cliques for the chordal graph;
solving for a plurality of marginal distributions of the maximal cliques; and
constructing the generative probability distribution using the marginal distributions.

7. The method recited in claim 1, wherein converting the Markov network to a chordal graph comprises adding one or more additional edges to the Markov network.

8. The method recited in claim 1, wherein identifying the generative probability distribution comprises:
constructing a Markov network for a data generation problem (DGP) comprising the cardinality constraints and the database table, wherein the Markov network comprises a graph comprising one or more vertices and one or more edges between the vertices;
identifying one or more maximal cliques for the Markov network;
solving for a plurality of marginal distributions of the maximal cliques; and
constructing the generative probability distribution using the marginal distributions.

9. A system for data generation, comprising:
a processing unit; and
a system memory, wherein the system memory comprises code configured to direct the processing unit to:
construct a Markov network for a data generation problem (DGP) comprising one or more cardinality constraints for populating a database table, wherein the Markov network comprises a graph comprising one or more vertices and one or more edges between the vertices;
convert the Markov network to a chordal graph;
identify one or more maximal cliques for the chordal graph;
solve for a plurality of marginal distributions of the maximal cliques;
construct a generative probability distribution using the marginal distributions;
select one or more values for a corresponding one or more attributes in the database table based on the generative probability distribution and the cardinality constraints; and
generate a tuple for the database table, wherein the tuple comprises the one or more values.

10. The system recited in claim 9, wherein the code configured to direct the processing unit to convert the Markov network to a chordal graph comprises code configured to direct the processing unit to add one or more additional edges to the Markov network.

11. The system recited in claim 9, wherein each of the cardinality constraints specifies:
the one or more attributes;
a query predicate; and
a cardinality of a result of running a database query comprising the query predicate against the database table.

12. The system recited in claim 11, wherein the generative probability distribution satisfies a property that for each constraint of the cardinality constraints, the probability that the query predicate is true for a tuple sampled from the generative probability distribution is k/N, where k comprises the cardinality, and N comprises a number of tuples in the database table.

13. The system recited in claim 11, wherein one of the cardinality constraints represents a preferred characteristic of a database comprising the database table.

14. The system recited in claim 13, wherein the preferred characteristic is naturalness, and wherein the cardinality is zero, and wherein the query predicate specifies a comparison between a source table comprising natural attribute values and the database table comprising the values.

15. One or more computer-readable storage media, comprising code configured to direct a processing unit to:
construct a Markov network for a data generation problem (DGP) comprising a plurality of cardinality constraints for populating one or more database tables, wherein the Markov network comprises a graph comprising one or more vertices and one or more edges between the vertices;
identify one or more maximal cliques for the Markov network;
solve for a plurality of marginal distributions of the maximal cliques;
construct the generative probability distribution using the marginal distributions;
select one or more values for a corresponding one or more attributes in the database tables based on the generative probability distribution and the cardinality constraints; and
generate a plurality of tuples for the plurality of database tables, wherein each of the tuples comprises the one or more values.

16. The one or more computer-readable storage media recited in claim 15, wherein each of the cardinality constraints specifies:
the one or more attributes;
a query predicate; and
a cardinality of a result of running a database query comprising the query predicate against the database table.

17. The one or more computer-readable storage media recited in claim 16, wherein the values are constrained by a plurality of intervals comprising constants specified by each query predicate.

18. The one or more computer-readable storage media recited in claim 15, wherein the generative probability distribution satisfies a property that for each constraint of the cardinality constraints, the probability that the query predicate is true for a tuple sampled from the generative probability distribution is k/N, where k comprises the cardinality, and N comprises a number of tuples in the database table.

19. The one or more computer-readable storage media recited in claim 18, wherein one of the cardinality constraints represents a preferred characteristic of a database comprising the database table.

20. The one or more computer-readable storage media recited in claim 19, wherein the preferred characteristic is naturalness, and wherein the cardinality is zero, and wherein the query predicate specifies a comparison between a source table comprising natural attribute values and the database table comprising the values.
